(19) United States
(12) Patent Application Publication
(10) Pub. No.: US 2018/0254528 A1
(43) Pub. Date: Sep. 6, 2018

(54) ALKALINE SECONDARY BATTERY

(71) Applicants: TOYOTA JIDOSHA KABUSHIKI KAISHA, Toyota-shi (JP); HIROSHIMA UNIVERSITY, Higashi-Hiroshima-shi (JP)

(72) Inventors: Haruyuki NAKANISHI, Nagoya-shi (JP); Yukihisa KATAYAMA, Nagoya-shi (JP); Yoshitsugu KOJIMA, Higashihiroshima-shi (JP)

(73) Assignees: TOYOTA JIDOSHA KABUSHIKI KAISHA, Toyota-shi (JP); HIROSHIMA UNIVERSITY, Higashi-Hiroshima-shi (JP)

(21) Appl. No.: 15/909,474

(22) Filed: Mar. 1, 2018

(30) Foreign Application Priority Data
Mar. 2, 2017 (JP) 2017-039517

(51) Int. Cl. H01M 10/30; H01M 10/26; H01M 10/28; H01M 10/04; H01M 4/50; H01M 4/24

(52) U.S. Cl. CPC H01M 10/30; H01M 10/26; H01M 10/286; H01M 2004/028; H01M 4/50; H01M 4/242; H01M 10/0459

(57) ABSTRACT

An alkaline secondary battery includes at least a positive electrode, a negative electrode, and an electrolytic solution. The positive electrode includes at least one of manganese oxyhydroxide and manganese dioxide. The negative electrode includes a hydrogen storage alloy.

### INCORPORATION BY REFERENCE

The disclosure of Japanese Patent Application No. 2017-039517 filed on Mar. 2, 2017 including the specification, drawings and abstract is incorporated herein by reference in its entirety.

### BACKGROUND

### 1. Technical Field

The present disclosure relates to an alkaline secondary battery.

### 2. Description of Related Art

Japanese Unexamined Patent Application Publication No. 61-158667 (JP 61-158667 A) discloses a nickel electrode for an alkaline secondary battery.

### SUMMARY

Alkaline secondary batteries such as nickel cadmium batteries and nickel hydrogen batteries have been applied in practice. In the related art, a nickel electrode is used as a positive electrode of an alkaline secondary battery. The present disclosure provides a novel alkaline secondary battery.

A technical configuration and operations and effects of the present disclosure will be described below. However, the mechanism of action of the present disclosure includes estimation. The scope of the claims should not be regarded as being limited according to the accuracy of the mechanism of action.

An aspect of the present disclosure relates to an alkaline secondary battery that includes at least a positive electrode, a negative electrode, and an electrolytic solution. The positive electrode includes at least one of manganese oxyhydroxide and manganese dioxide. The negative electrode includes a hydrogen storage alloy.

The above alkaline secondary battery is a novel alkaline secondary battery. The alkaline secondary battery is considered to operate according to the following reactions.
Positive electrode reaction: (charging) MnO₂+H₂O+e⁻↔MnOOH+OH⁻(discharging)
First negative electrode reaction: (charging) MH+OH⁻↔M+H₂O+e⁻(discharging)
First cell reaction: (charging) MnO₂+MH↔MnOOH+M (discharging)

In the nickel electrode in the related art, a positive electrode active material is at least one of nickel oxyhydroxide (NiOOH) and nickel hydroxide [Ni(OH)₂]. NiOOH turns into Ni(OH)₂ according to discharging. A discharging capacity at this time is considered to be about 292 mAh per 1 g of NiOOH.

In the alkaline secondary battery of the present disclosure, a positive electrode active material is at least one of manganese dioxide (MnO₂) and manganese oxyhydroxide (MnOOH). MnO₂ turns into MnOOH according to discharging. A discharging capacity at this time is considered to be about 308 mAh per 1 g of MnO₂. Therefore, the alkaline secondary battery of the present disclosure is expected to have a larger capacity than the alkaline secondary battery in the related art.

The alkaline secondary battery may further include hydrogen gas.

In this specification, a state before initial charging and discharging are performed in the alkaline secondary battery will be referred to as an “initial state.” As described above, the positive electrode includes at least one of MnOOH and MnO₂ as the positive electrode active material. In the initial state, the positive electrode active material may be in a discharged state (MnOOH) or a charged state (MnO₂).

In the initial state, when the positive electrode active material is in a discharged state (MnOOH), the alkaline secondary battery starts a charging operation. In the initial state, when the positive electrode active material is in a charged state (MnO₂), the alkaline secondary battery starts a discharging operation. At a state of charge (SOC) of 0% to 100% after initial charging and discharging, at least one of MnOOH and MnO₂ is always included in the positive electrode.

However, in the initial state, when the positive electrode active material is in a charged state, the negative electrode active material (hydrogen storage alloy) also needs to be in a charged state. When the alkaline secondary battery further includes hydrogen gas, it is expected that the hydrogen gas is occluded in the hydrogen storage alloy and the hydrogen storage alloy is charged.

Here, the hydrogen gas occluded in the hydrogen storage alloy is considered to be hydrogen in an atomic state. As shown in the above “first negative electrode reaction,” hydrogen released from the hydrogen storage alloy is assumed to combine with hydroxide ions (OH⁻) to form water (some of the electrolytic solution). Hydrogen in an atomic state and hydrogen gas are in different states, and need to be distinguished from each other. That is, the alkaline secondary battery may include hydrogen gas separately from hydrogen that is occluded in and released from the hydrogen storage alloy.

The hydrogen gas included in the alkaline secondary battery is expected to function as the negative electrode active material. That is, the following second negative electrode reaction is expected to occur in the negative electrode reactions. As a result, the cell reactions are expected to include the following second cell reaction. Therefore, a capacity of the alkaline secondary battery is expected to be larger.

Second negative electrode reaction: (charging) 1/2H₂+OH⁻↔H₂O+e⁻(discharging)
Second cell reaction: (charging) 2MnO₂+MH+1/2H₂↔2MnOOH+M (discharging)

In the pressure-composition isotherm diagram, an emission line of the hydrogen storage alloy at 25° C. has a plateau pressure. The hydrogen gas may have a pressure that exceeds the plateau pressure.

The “plateau pressure” refers to a pressure at which the hydrogen storage alloy can reversibly occlude and release hydrogen. When the hydrogen gas has a pressure that exceeds the plateau pressure, prevention of generation of hydrogen gas during charging (that is, when the hydrogen storage alloy occludes hydrogen) is expected. Therefore, charging efficiency of the alkaline secondary battery is expected to be improved.

The hydrogen storage alloy may be an AB₅ alloy, and the plateau pressure may be 0.15 MPa or more.

In this specification, an AB₅ alloy having a plateau pressure of 0.15 MPa or more will be denoted as a “high dissociation pressure AB₅ alloy.” On the other hand, a hydrogen storage alloy having a plateau pressure of less than 0.15 MPa will be denoted as a “low dissociation pressure AB₅ alloy.”

In nickel hydrogen batteries of the related art, the low dissociation pressure AB₅ alloy is used as the negative electrode active material. The low dissociation pressure AB₅ alloy has a reversible hydrogen storage capacity of about 1.0 mass % to 1.1 mass %. On the other hand, the high dissociation pressure AB₅ alloy has a reversible hydrogen storage capacity of 1.3 mass % to 1.5 mass %. Therefore, when the negative electrode active material includes the high dissociation pressure AB₅ alloy, a capacity of the alkaline secondary battery is expected to be larger.

Further, when the plateau pressure is higher, a higher discharging voltage (that is, a higher output) is expected based on Nernst's equation.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a conceptual diagram showing an example of a configuration of an alkaline secondary battery according to an embodiment of the present disclosure;

FIG. 2 shows an example of a pressure-composition isotherm diagram of a low dissociation pressure AB₅ alloy; and

FIG. 3 shows an example of a pressure-composition isotherm diagram of a high dissociation pressure AB₅ alloy.

### DETAILED DESCRIPTION OF EMBODIMENTS

An embodiment (hereinafter referred to as “the present embodiment”) of the present disclosure will be described below. However, the following description does not limit the present disclosure. An “alkaline secondary battery” will be simply referred below to as a “battery.” In this specification, for example, “at least one of A and B” includes “only A,” “only B” and “both A and B.”

<Alkaline Secondary Battery>

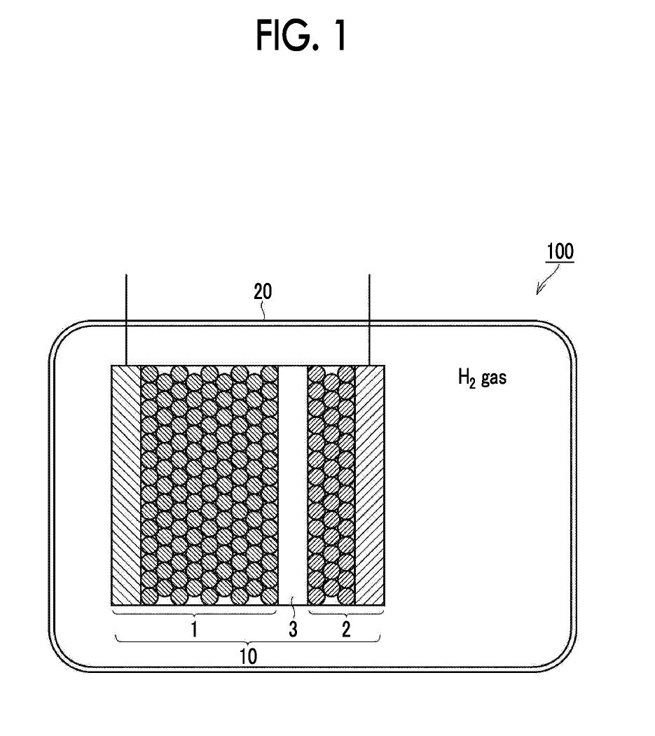

FIG. 1 is a conceptual diagram showing an example of a configuration of an alkaline secondary battery according to an embodiment of the present disclosure. A battery 100 includes a housing 20. The housing 20 is sealed. An electrode group 10 and an electrolytic solution (not shown) are housed in the housing 20. Hydrogen gas may be filled into the housing 20. In this case, the housing 20 is assumed to have a structure that can withstand a pressure of the hydrogen gas. The housing 20 may be, for example, a pressure container.

The electrode group 10 includes a positive electrode 1, a negative electrode 2, and a separator 3. The positive electrode 1 faces the negative electrode 2 with the separator 3 interposed therebetween. The electrolytic solution is impregnated into the positive electrode 1, the negative electrode 2, and the separator 3. That is, the battery 100includes at least the positive electrode 1, the negative electrode 2, and the electrolytic solution. The separator 3 is disposed between the positive electrode 1 and the negative electrode 2. For example, the electrode group 10 may be formed by alternately laminating the positive electrode 1 and the negative electrode 2 with the separator 3 therebetween. The electrode group 10 may be formed by the positive electrode 1, the separator 3, and the negative electrode 2 being wound in a spiral shape.

<Positive Electrode>

The positive electrode 1 may have, for example, a plate shape or a sheet shape. The planar shape thereof may be, for example, a belt shape or a rectangular shape. The thickness of the positive electrode 1 may be, for example, about 10 μm to 1 mm. The positive electrode 1 includes at least one of MnO₂ and MnOOH. MnO₂ may be, for example, electrolytic manganese dioxide.

MnO₂ and MnOOH function as a positive electrode active material. MnO₂ is in a charged state, and MnOOH is in a discharged state. “At least one of MnOOH and MnO₂” will be referred below to as a “positive electrode active material.”

The positive electrode 1 may include other materials as long as it includes the positive electrode active material. For example, the positive electrode 1 may be an electrode in which positive electrode active material powder is held on a predetermined base material. The positive electrode active material powder may have an average particle size of, for example, 1 μm to 30 μm. The “average particle size” in this specification refers to a particle size of cumulative 50% from the side of fine particles in a volume-based particle size distribution measured according to a laser diffraction scattering method.

The base material may be, for example, a porous metal, or a perforated metal plate (punching metal). Examples of the porous metal include a foamed nickel substrate. In the base material, a conductive material, a binder, and the like are held together with the positive electrode active material.

The conductive material is not particularly limited. The conductive material may be, for example, carbon black, vapor grown carbon fibers (VGCF), graphite, cobalt oxide (CoO), or cobalt hydroxide [Co(OH)₂]. One type of conductive material may be used alone, or two or more types of conductive material may be used in combination. The conductive material may have a mass ratio of, for example, 0.1 mass % to 20 mass %, with respect to the positive electrode active material.

The binder is not particularly limited. The binder may be, for example, carboxymethyl cellulose (CMC), polyvinyl alcohol (PVA), polytetrafluoroethylene (PTFE) tetrafluoroethylene-perfluoroalkyl vinyl ether copolymer (PFA), tetrafluoroethylene-hexafluoropropylene copolymer (FEP), styrene butadiene rubber (SBR), or acrylonitrile butadiene rubber (NBR). One type of binder may be used alone, or two or more types of binder may be used in combination. The binder may have a mass ratio of, for example, about 0.1 mass % to 10 mass %, with respect to the positive electrode active material.

<Negative Electrode>

The negative electrode 2 may have, for example, a plate shape or a sheet shape. The planar shape thereof may be, for example, a belt shape or a rectangular shape. The thickness of the negative electrode 2 may be, for example, about 10 μm to 1 mm. The negative electrode 2 includes a hydrogen storage alloy. The negative electrode 2 may be, for example, a molded article of the hydrogen storage alloy. The negative electrode 2 may include other materials as long as it includes the hydrogen storage alloy. For example, the negative electrode 2 may be an electrode in which hydrogen storage alloy powder is held on a predetermined base material. The hydrogen storage alloy powder may have an average particle size of, for example, 1 μm to 30 μm. The base material may be, for example, a porous metal (such as a foamed nickel substrate) or a punching metal. In the base material, a conductive material, a binder, and the like may be held together with the hydrogen storage alloy.

The conductive material is not particularly limited. The conductive material may be, for example, Cu powder, Ni powder, or a material exemplified as the conductive material of the positive electrode 1. One type of conductive material may be used alone or two or more types of conductive material may be used in combination. The conductive material may have a mass ratio of, for example, 0.1 mass % to 20 mass %, with respect to the hydrogen storage alloy.

The binder is not particularly limited. The binder may be, for example, a material exemplified as the binder of the positive electrode 1. One type of binder may be used alone, or two or more types of binder may be used in combination. The binder may have a mass ratio of, for example, 0.1 mass % to 10 mass %, with respect to the hydrogen storage alloy.

(Hydrogen Storage Alloy)

The hydrogen storage alloy is an alloy that reversibly occludes and releases hydrogen. The hydrogen storage alloy functions as the negative electrode active material. The hydrogen storage alloy is not particularly limited. Examples of the hydrogen storage alloy include an AB alloy (for example, TiFe), an AB₂ alloy (for example, ZrMn₂, ZrV₂, and ZrNi₂), an A₂B alloy (for example, Mg₂Ni and Mg₂Cu), and an AB₅ alloy (for example, CaNi₅, LaNi₅, and MmNi₅). One type of hydrogen storage alloy may be used alone or two or more types of hydrogen storage alloy may be used in combination.

“Mm” in “MmNi₅” indicates a mischmetal (similarly applies to other formulae). The “mischmetal” indicates a rare earth element mixture including Ce and La as main components. When it is described that “Ce and La are main components,” this means that a sum of Ce and La is 50 mass % or more of the entire mixture. Mm may include Nd, Pr, Sm, Mg, Al, Fe, and the like in addition to Ce and La. Mm may include, for example, 40 mass % to 60 mass % of Ce, 10 mass % to 35 mass % of La, and the balance of Nd, Pr and Sm. Mm may include, for example, 53.7 mass % of Ce, 24.1 mass % of La, 16.5 mass % of Nd, and 5.8 mass % of Pr.

The hydrogen storage alloy may be, for example, the AB₅ alloy. The AB₅ alloy is expected to have a large reversible capacity at near room temperature. The AB₅ alloy may be, for example, a low dissociation pressure AB₅ alloy. In the pressure-composition isotherm diagram, an emission line of the low dissociation pressure AB₅ alloy at 25° C. has a plateau pressure of less than 0.15 MPa.

Examples of the low dissociation pressure AB₅ alloy include MmNi_{4.2}Co_{0.2}Mn_{0.5}Al_{0.3} (0.02 MPa), MmNi_{4.0}Fe_{1.0} (0.10 MPa), MmNi_{4.2}Mn_{0.8} (0.10 MPa), and MmNi_{4.1}Al_{0.9} (0.10 MPa). The pressure in parentheses is a plateau pressure.

The “plateau pressure” is measured as follows. First, an “emission line at “25° C.” is measured. The emission line is measured by a method according to “JISH7201.” A Sievert device known in the related art may be used for measurement. When measurement is performed, if a thermometer disposed in a sample chamber (constant temperature chamber) indicates “25° C.±1° C.,” the emission line at 25° C. is considered to have been measured.

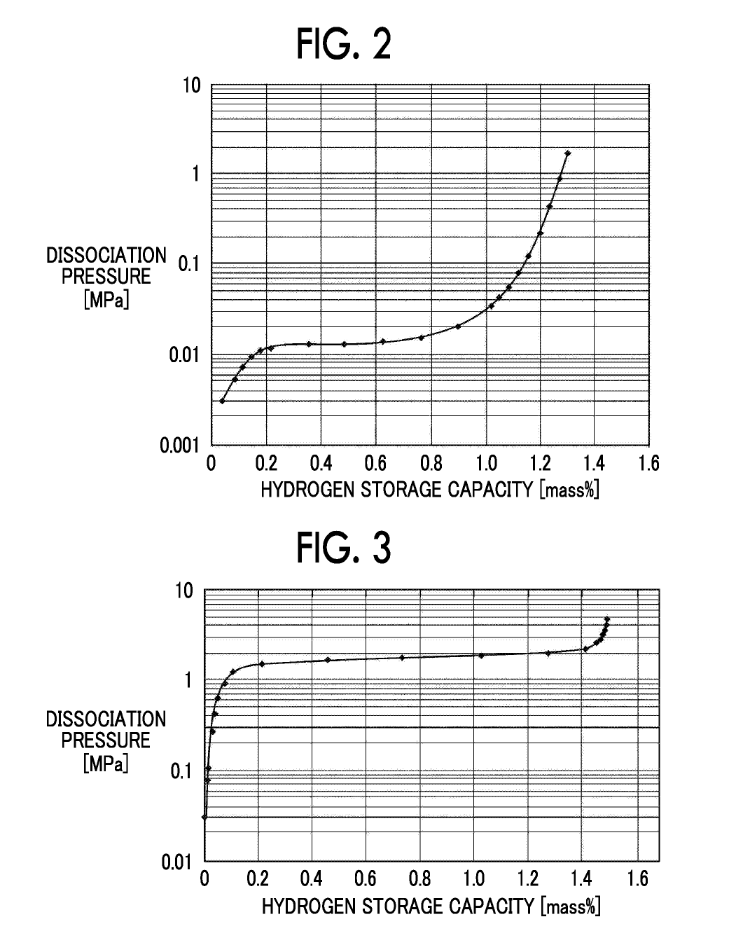

FIG. 2 is an example of a pressure-composition isotherm diagram of the low dissociation pressure AB₅ alloy. The pressure-composition isotherm diagram is also called a “PCT diagram.” In the PCT diagram, the vertical axis represents a dissociation pressure, and the vertical axis has a common logarithmic scale. The horizontal axis represents a hydrogen storage capacity. The emission line at 25° C. is created by connecting at least 10 measurement points, and preferably 20 measurement points.

The “plateau pressure” is determined as follows. A straight line passing through three consecutive points in the emission line is drawn. The slope of the straight line is obtained. When three points are not on one straight line, the slope of the straight line is obtained by the least squares method. A combination of three points at which the slope is minimized is determined. An arithmetic average value of dissociation pressures at these three points is determined as the “plateau pressure.”

The AB₅ alloy may be a high dissociation pressure AB₅ alloy. In the PCT diagram, an emission line at 25° C. of the high dissociation pressure AB₅ alloy has a plateau pressure of 0.15 MPa or more. That is, the hydrogen storage alloy may be the AB₅ alloy and the plateau pressure may be 0.15 MPa or more. The high dissociation pressure AB₅ alloy is expected to have a large reversible capacity. FIG. 3 is an example of a pressure-composition isotherm diagram of the high dissociation pressure AB₅ alloy. A magnitude of the reversible capacity is thought to have a correlation with the length of a part in which the emission line is flat in the PCT diagram.

Examples of the high dissociation pressure AB₅ alloy include MmNi₅ (2.3 MPa), MmNi_{4.7}Fe_{0.3} (1.6 MPa), MmNi_{4.5}Cr_{0.5} (0.57 MPa), MmNi_{4.2}Co_{0.8} (2.1 MPa), MmNi_{4.5}Mn_{0.5} (0.33 MPa), MmNi_{4.5}Al_{0.5} (0.38 MPa), MmNi_{4.5}Cr_{0.45}Mn_{0.05} (0.30 MPa), MmNi_{4.5}Cr_{0.25}Mn_{0.25} (0.20 MPa), and LaNi₅ (0.15 MPa). The pressure in parentheses is a plateau pressure.

That is, the AB₅ alloy may be at least one selected from the group consisting of MmNi₅, MmNi_{4.7}Fe_{0.3}, MmNi_{4.5}Cr_{0.5}, MmN_{4.2}Co_{0.8}, MmNi_{4.5}Mn_{0.5}, MmNi_{4.5}Al_{0.5}, MmNi_{4.5}Cr_{0.45}Mn_{0.05}, MmNi_{4.5}Cr_{0.25}Mn_{0.25}, and LaNi₅. The AB₅ alloy may be at least one of MmNi_{4.2}Co_{0.8} and LaNi₅.

The high dissociation pressure AB₅ alloys listed here can be represented by, for example, the following Formula (I):

MNiₐFe_{b}Cr_{c}Mn_{d}AlₑCo_{f} (I)

[where, in the formula, M denotes Mm or La, a, b, c, d, e, and f satisfy 4<a≤5, 0≤b<0.6, 0≤c<0.6, 0≤d<0.6, 0≤e<0.6, 0≤f<1, b+c+d+e<0.6]

When the plateau pressure is higher, a higher discharging voltage (that is, a higher output) is expected based on Nernst's equation. The plateau pressure of the high dissociation pressure AB₅ alloy may be, for example, 0.20 MPa or more, 0.30 MPa or more, 0.33 MPa or more, 0.38 MPa or more, or 0.57 MPa or more. The plateau pressure may be, for example, 10 MPa or less, 2.3 MPa or less, or 2.1 MPa or less.

<Hydrogen gas>

Hydrogen gas may be filled into the housing 20. That is, the battery 100 may further include hydrogen gas. When the battery 100 includes the hydrogen gas, the positive electrode active material in the initial state may be MnO₂ (charged state).

Further, the hydrogen gas is expected to function as the negative electrode active material. When the hydrogen gas functions as the negative electrode active material, the negative electrode 2 may become a “hybrid negative electrode” including both a solid active material (hydrogen storage alloy) and a gaseous active material (hydrogen gas). According to the hybrid negative electrode, a capacity of the battery 100 is expected to be larger.

The hydrogen gas may have, for example, a pressure that exceeds the plateau pressure of the hydrogen storage alloy at 25° C. Therefore, prevention of generation of hydrogen gas during charging (that is, when the hydrogen storage alloy occludes hydrogen) is expected. Therefore, charging efficiency of the battery 100is expected to be improved.

The hydrogen gas may be a high pressure gas. When the hydrogen gas (gaseous active material) is compressed more, a volume energy density of the battery 100 is expected to increase. A pressure of the hydrogen gas may be measured using a pressure gauge. The housing 20 may include the pressure gauge. For example, at 25° C., the hydrogen gas may have a pressure of 1 MPa or more and 100 MPa or less, a pressure of 3 MPa or more and 70 MPa or less, a pressure of 5 MPa or more and 50 MPa or less, a pressure of 10 MPa or more and 30 MPa or less, or a pressure of 10 MPa or more and 20 MPa or less.

<Electrolytic solution>

The electrolytic solution is an alkaline aqueous solution. The electrolytic solution may be, for example, a potassium hydroxide (KOH) aqueous solution. The electrolytic solution may be a sodium hydroxide (NaOH) aqueous solution or a lithium hydroxide (LiOH) aqueous solution. The electrolytic solution may include one type of hydroxide alone or two or more types of hydroxide. For example, the electrolytic solution may have a concentration of about 1 mol/l to 20 mol/l or a concentration of about 5 mol/l to 10 mol/l.

<Separator>

The separator 3 is not particularly limited. The separator 3 may have, for example, a sheet shape. The thickness of the separator 3 may be, for example, 10 μm to 500 μm. The separator 3 may be, for example, a material known in the related art as a separator of a nickel hydrogen battery. The separator 3 may be, for example, a nonwoven fabric such as polyolefin fibers and polyamide fibers. The nonwoven fabric may have a basis weight of, for example, 50 g/m² to 100 g/m².

The separator 3 may be a porous film made of a polyolefin. The polyolefin may be, for example, polyethylene or polypropylene. The separator 3 may have hydrophilicity imparted thereto. Hydrophilicity may be imparted to the separator 3 according to, for example, a sulfonation treatment, or a plasma treatment.

Examples of the present disclosure will be described below. However, the following examples do not limit the scope of the appended claims.

### EXAMPLE 1

1. Producing Positive Electrode

An aqueous solution including 1 mol/l ammonia and 10 mass % of hydrogen peroxide was prepared. The aqueous solution was added dropwise to a manganese chloride aqueous solution (1 mol/l). Therefore, a precipitate was generated. The precipitate was recovered. The precipitate was washed with pure water. The washed precipitate was dried. Thereby, a dry solid (MnOOH) was prepared.

A 0.7 mass % CMC aqueous solution was prepared. MnOOH powder and the CMC aqueous solution were mixed. Thereby, a positive electrode paste was prepared

A foamed nickel substrate having a thickness of 1.4 mm was prepared. The positive electrode paste was impregnated into the foamed nickel substrate and dried. Thereby, a positive electrode was produced. The positive electrode was rolled so that it had a thickness of 0.6 mm. The positive electrode was cut into a belt shape. The cut positive electrode was designed so that it had a discharging capacity of 1730 mAh. In designing, MnOOH was assumed to have a discharging capacity of 305 mAh/g.

2. Producing negative electrode

Mm powder, Ni powder, and Co powder were prepared. The Mm powder, the Ni powder, and the Co powder were melted in an arc melting furnace in an argon atmosphere. Thereby, a molten alloy was prepared. The molten alloy was cooled. Thereby, a hydrogen storage alloy was obtained. The hydrogen storage alloy was crushed. Thereby, a hydrogen storage alloy powder was obtained. The powder had a particle size of 50 μm or less. The hydrogen storage alloy was MmNi_{4.2}Co_{0.8}. MmNi_{4.2}Co_{0.8} was a high dissociation pressure AB₅ alloy. An emission line of MmNi_{4.2}Co_{0.8} at 25° C. had a plateau pressure of 2.1 MPa.

The hydrogen storage alloy powder, a CMC aqueous solution, and a PTFE aqueous dispersion were mixed. Thereby, a negative electrode paste was prepared. A punching metal was prepared. The negative electrode paste was applied to both surfaces of the punching metal and dried. Thereby, a negative electrode was produced. The negative electrode was rolled so that it had a thickness of 0.6 mm. The negative electrode was cut into a belt shape. The cut negative electrode was designed so that it had a charging capacity of 2600 mAh (a charging capacity about 1.5 times a charging capacity of the positive electrode).

3. Assembling

As a separator, a nonwoven fabric made of polyolefin resin fibers was prepared. The separator had a thickness of 150 μm. The positive electrode, the separator, and the negative electrode were disposed so that the positive electrode faced the negative electrode with the separator therebetween. The positive electrode, the separator, and the negative electrode were wound in a spiral shape. Thus, the electrode group was formed. A housing was prepared. The housing was a metal case having a lid. The housing had a cylindrical outer shape. The electrode group was housed in the housing. An electrolytic solution was injected into the housing. The electrolytic solution was a KOH aqueous solution (7 mol/l). The housing was sealed.

Thus, the alkaline secondary battery according to Example 1 was produced. The battery had a size of AA. The battery was designed so that it had a rated discharging capacity of 1730 mAh.

### EXAMPLE 2

A battery was produced in the same manner as in Example 1 except that LaNi₅ was prepared as a hydrogen storage alloy. LaNi₅ was a high dissociation pressure AB₅ alloy. An emission line of LaNi₅ at 25° C. had a plateau pressure of 0.15 MPa.

### COMPARATIVE EXAMPLE 1

A battery was produced in the same manner as in Example 1 except that zinc oxide (ZnO) powder was used as the negative electrode active material.

### EXAMPLE 3

A positive electrode was produced in the same manner as in Example 1 except that MnO₂ was used as the positive electrode active material. In the same manner as in Example 1, an electrode group was formed. The negative electrode included MmNi_{4.2}Co_{0.8}. The electrode group and the electrolytic solution were housed in the housing. Hydrogen gas was filled into the housing. The hydrogen gas was filled in so that it had a pressure that exceeded 2.1 MPa (plateau pressure of MmNi_{4.2}Co_{0.8}). The housing was sealed. Thus, the battery was produced. In this example, the battery included the hydrogen gas.

### EXAMPLE 4

A battery was produced in the same manner as in Example 3 except that LaNi₅ was used as the negative electrode active material, and hydrogen gas was filled into the housing so that it had a pressure that exceeded 0.15 MPa (plateau pressure of LaNi₅). In this example, the battery included the hydrogen gas.

### COMPARATIVE EXAMPLE 2

In the same manner as in Example 3, a positive electrode including MnO₂ as a positive electrode active material was produced. A negative electrode was produced in the same manner as in the other examples except that Zn powder was used as the negative electrode active material. Except for this, a battery was produced in the same manner as in Comparative Example 1.

### COMPARATIVE EXAMPLE 3

A battery was produced in the same manner as in Example 1 except that NiOOH was used as the positive electrode active material, and MmNi_{4.2}Co_{0.2}Mn_{0.5}Al_{0.3} was used as the negative electrode active material. MmNi_{4.2}Co_{0.2}Mn_{0.5}Al_{0.3} was a low dissociation pressure AB₅ alloy. An emission line of MmNi_{4.2}Co_{0.2}Mn_{0.5}Al_{0.3} at 25° C. had a plateau pressure of 0.02 MPa.

<Charging and Discharging Test>

The batteries were fully charged (SOC=100%) in an environment at 20° C. according to the following two-step charging.
First step: current=100 mA, charging time=6 hours
Second step: current=120 mA, charging time=16 hours

The battery was discharged at a current of 260 mA. Discharging was terminated when a voltage between terminals was lower than 1 V. The charging capacity and the discharging capacity are shown in the following Table 1.

TABLE 1
List of examples and comparative examples

| | Positive | Negative | Charging | Discharging | Discharging |
|---|---|---|---|---|---|
| | electrode | electrode | capacity | capacity | cutoff voltage |
| | (initial state) | (initial state) | [mAh] | [mAh] | [V] |
| Example 1 | MnOOH | MmNi_{4.2}Co_{0.8} | 1920 | 1730 | 1 |
| Example 2 | MnOOH | LaNi₅ | 1920 | 1730 | 1 |
| Comparative | MnOOH | ZnO | Charging | Discharging | — |
| Example 1 | | | was not | was not | |
| | | | possible | possible | |
| Example 3 | MnO₂ | MmNi_{4.2}Co_{0.8} + H₂(g) | 1920 | 1730 | 1 |
| Example 4 | MnO₂ | LaNi₅ + H₂(g) | 1920 | 1730 | 1 |
| Comparative | MnO₂ | Zn | Charging | 1730 | 1 |
| Example 2 | | | was not | | |
| | | | possible | | |
| Comparative | NiOOH | MmNi_{4.2}Co_{0.2}Mn_{0.5}Al_{0.3} | 1830 | 1650 | 1 |
| Example 3 | | | | | |

<Results>

As shown in Table 1, all of the examples were secondary batteries capable of charging and discharging. Comparative Example 3 had the same configuration as in the nickel hydrogen battery of the related art. Examples had a larger discharging capacity than Comparative Example 3. MnOOH and MnO₂ are considered to have a larger capacity than NiOOH and Ni(OH)₂.

In addition, a larger capacity of the high dissociation pressure AB₅ alloy (MmNi_{4.2}Co_{0.8} and LaNi₅) with respect to the low dissociation pressure AB₅ alloy (MmNi_{4.2}Co_{0.2}Mn_{0.5}Al_{0.3}) was thought to influence a capacity difference between the Examples and Comparative Example 3.

In Comparative Example 1, charging and discharging were not possible. This is thought to be caused by the fact that ZnO used for the negative electrode active material was inactive and no oxidation-reduction reaction occurred. Comparative Example 2 had the same configuration as in a so-called alkaline manganese dry cell. In Comparative Example 2, discharging was possible, but charging was not possible. This is thought to be caused by the fact that Zn could be oxidized to ZnO, but ZnO could not be reduced to Zn.

The above embodiment and examples are only examples in all respects and should not be considered as restrictive. The technical scope determined by the scope of the appended claims includes meanings equivalent to the scope of the claims and all modifications in the scope.

What is claimed is:

1. An alkaline secondary battery comprising:
a positive electrode;
a negative electrode; and
an electrolytic solution
wherein the positive electrode includes at least one of manganese oxyhydroxide and manganese dioxide, and
wherein the negative electrode includes a hydrogen storage alloy.

2. The alkaline secondary battery according to claim 1, further comprising hydrogen gas.

3. The alkaline secondary battery according to claim 2,
wherein, in a pressure-composition isotherm diagram, an emission line at 25° C. of the hydrogen storage alloy has a plateau pressure, and
wherein the hydrogen gas has a pressure that exceeds the plateau pressure.

4. The alkaline secondary battery according to claim 3,
wherein the hydrogen storage alloy is an AB₅ alloy, and
wherein the plateau pressure is 0.15 MPa or more.
